(19) United States
(12) Patent Application Publication
(10) Pub. No.: US 2021/0035410 A1
(43) Pub. Date: Feb. 4, 2021

(54) LOYALTY APPLICATION FOR MOBILE DEVICES

(71) Applicants: Michael BROWNING, JR., Bedford, TX (US); Maria Teresa DIAZ, Pasadena, CA (US)

(72) Inventors: Michael BROWNING, JR., Bedford, TX (US); Maria Teresa DIAZ, Pasadena, CA (US)

(21) Appl. No.: 16/983,180

(22) Filed: Aug. 3, 2020

Related U.S. Application Data
(60) Provisional application No. 62/881,532, filed on Aug. 1, 2019.

(51) Int. Cl. G07F 17/32; G06K 19/077

(52) U.S. Cl. CPC G07F 17/3255; G06K 19/07762; G07F 17/3276; G07F 17/3239

(57) ABSTRACT

The method comprises providing a system comprising a server, a network, a controller, and one or more scanner devices, the server being communicatively linked to the network and the controller, the one or more scanner devices being adapted to receive identification data communicated by an identifier device such as an RFID device. The system is adapted to maintain player account data and scanner device data. The player account data comprises a player account. The scanner device data comprises data associated with the one or more scanner devices. The player account is associated with the identifier device. A player account award credit is generating when at least one of the one or more scanner devices receives the identification data communicated by the identifier device. The award credit is displayed on the mobile device. Group credits are generated when group members earn award credits.

This application claims the benefit of provisional application, application No. 62/881,532, filed Aug. 1, 2019, which is incorporated by reference.

### FIELD OF THE INVENTION

The present invention relates to software for use in mobile devices such as smartphones.

### BACKGROUND OF THE INVENTION

Amusement parks and family entertainment centers provide attractions to customers to enjoy. These venues can be either outdoor or indoor. One type of indoor park includes trampolines, climbing walls, obstacle courses, balance beams, ball pits, etc.

While the attractions themselves are fun and enjoyable. park operators continue to evolve the nature of the entertainment provided. This includes providing new attractions. This also includes providing competitive features to the attractions. Many of the attractions involve a single user, or involve users acting independently of one another. These make it difficult for users to compete.

It is desired to increase or provide competitive features to attractions in amusement parks and entertainment centers.

### BRIEF DESCRIPTION OF THE DRAWINGS

FIG. 1 is a diagram illustrating an amusement park with attractions.

FIG. 2 is a block diagram showing a system for use with the loyalty application.

FIG. 3 is a diagram illustrating the process of a user acquiring awards.

FIG. 4 is a diagram illustrating the process of a user redeeming awards.

### SUMMARY OF THE INVENTION

The loyalty application is used when the player, or user, visits an amusement park or other entertainment venue, which park is equipped with a suitable system. The player participates in various activities and attractions in the park. At least some of these activities yield awards to the player. The loyalty application allows the player to monitor the accumulated awards and also allows the player to redeem the awards for goods or services. The goods or services can be collected by the player in the park.

The loyalty application is used on a mobile device, such as a smartphone. The mobile device is possessed by a user. The loyalty application is used with an identification device, such as an RFID device. Such an RFID can be worn by the player, such as on a wristband.

The loyalty application allows players to share awards. For example, members of a family or other group may wish to share awards. Players can monitor the awards earned by the group and redeem those group awards. During the redemption process, available promotions can be used.

The loyalty application may be used in an amusement park or entertainment venue. The park can be indoors or outdoors. The park is a venue for entertainment activities. Such activities can involve physical play or can be games with little physical involvement. The park has a registration, or reception, desk near an entry or gate. A player, or customer, enters the park and goes to the reception area to purchase tickets, access passes, RFID devices, etc. The RFID device has a unique identifier. The player registers the player's RFID device, wherein the system establishes an account for the player, matches the identifier to the player, and obtains other information about the player for the account such as payment information, etc. The account also contains information on shared awards. The player is able to be part of a group of plural players. Each player is identified by an RFID device and identifier. Awards earned by any one player in the group can be shared among the group. The reception desk also serves to store the various prizes that players can acquire by earning and redeeming awards.

The park has a snack bar. Customers can purchase food and beverages at the snack bar. Purchases can be made in money or in redeemed awards.

The park has various attractions, or activities, such as trampolines, obstacle courses, climbing walls, etc. One attraction is a scavenger hunt. The scavenger hunt has scanner devices located throughout the park. A user, or player, hunts for and locates a scanner device, scans the RFID device, receives awards, and moves on to hunt for another scanner device. Locating a scanner device can be as simple as spotting one along a walkway, or as difficult as climbing a tall wall using handholds.

Another attraction is a video production area. A camera is provided. A user interface and RFID scanner are also provided. The player scans the RFID device with the scanner, interacts with the user interface to select a particular video to be made, then stands in the area in front of the camera. The camera turns on and records the user. The user interface includes a screen monitor to allow the player to view what is being recorded. The area can be provided with various backdrops. One general backdrop is a green screen, which allows images, or special effects, to be added by the system to the video.

Another attraction is an arena. Players enter the arena and interact therewith. Images can be projected onto the walls and a user can throw an object, such as a ball, onto the images. Participation can result in awards to the players.

The above are example attractions. The park can have other attractions, which may involve physical activities, such as jumping, climbing, balancing, etc., or may involve other activities.

The system has a server that is connected to a network. The server can be located at the park or in another location. The network is connected to various devices throughout the park. For a first attraction, namely the scavenger hunt, there are a number of the RFID scanner devices located throughout the park. For a second attraction, namely the video production area, the video production equipment, namely camera. RFID scanner and user interface, are provided. The equipment for other attractions, such as the arena, is provided as well, connected to the server over the network. The server is connected over the network to a controller, which controller can be located at the park or in another location. The controller can be application software on a mobile device such as a smartphone, tablet, etc.

The server is also connected, by way of the network, to plural player devices. Such player devices are, in the preferred embodiment, mobile phones and smartphones. Thus, a player can access the system while at the park. A player device can also be a desk computer, wherein the player can access the system from a home, etc. located outside of the park. In addition, the server is connected to one or more leaderboards located in the park. The leaderboards are large displays, typically elevated above the floor to allow viewing from many areas of the park.

The server has a network adapter, as does each component connected to the network such as the scanners, the video production equipment, the equipment for other attractions, the controller, the mobile devices and the leaderboards.

In the method of a preferred embodiment, a player acquires awards. The player engages in an activity that allows awards. step. Such an activity typically involves the player playing on or using the attraction. For example, for the scavenger hunt game, the player hunts the scanner devices throughout the park and scans the player's RFID device. Part of the activity is finding the scanner devices. Another part of the activity is reaching the scanner devices and locating the RFID devices adjacent thereto for scanning. To reach some of the scanner devices, the player may need to climb, balance on a beam or other object, traverse an elevated course, etc. As another example, to produce a video, a player scans in the player's RFID device at the scanner in the video area, selects from a library of available backdrops or video interactions, and steps in front of the camera. As the camera records, the player of course need not stay stationary, but can move and interact. For example, the equipment may provide a visual backdrop on the video, such as a surfing wave, wherein the player may wish to pantomime riding a surfboard. The player can view the video, with the surfing wave, in real time on a display. As another example, a player can share the completed video with others. Sharing can be on social media, such as with a collection of friends. Sharing can also be by emails or messaging with select individuals.

The method then determines if the player has finished the required activity. For the scavenger hunt, this is a successful scan of the RFID device. For the video production, this is a completed video. For sharing a video, this is the actual sharing to a common platform, such as a social media, or to a private recipient. All of these actions result in a notification sent to the server by the respective equipment. The notification provides the player's information. For example, in the case of a scanned RFID device, the identification from the RFID device is included.

The player's identification from the attraction is matched to the player and the player's account. In addition, the amount of awards earned by the player, if any, is determined. Various predetermined factors can be used to determine the amount of awards, such as time of day, particular attraction or activity the player engaged in, level of difficulty. Also, various rules may be applied to determine rewards. For example, when playing the scavenger hunt, a player may be unable to rescan plural times the same scanner in a predetermined period of time, so as to encourage players to hunt for other scanners. The awards earned by the player are stored in a database, namely in the player's account.

In addition, the method determines the shared awards of the player. The group that the player belongs to is identified and the awards accumulated by the group are added to or updated in the player's account. Shared awards allow a parent or guardian to monitor and redeem awards on behalf of several young players. Such young players may not have a mobile device themselves and may need to rely on the mobile device of the parent.

The player is allowed to view the player's account by way of a player device. The method also determines who the leaders are among active playing players in the park and displays a ranking on the leaderboard. This allows players in the park to compete against one another.

A method for allowing a player, or parent, to monitor awards and redeem rewards is also provided. A player uses the loyalty application on the mobile device. The player monitors the awards earned. The player can monitor how the awards were earned, whether from making videos, or playing games, such as the scavenger hunt, etc. The player can also monitor how many times items, such as videos, were shared by the player to another player or platform (such as social media). The player can monitor the awards earned by the player individually and by the player's group.

Occasionally, promotions may be made available to player. A promotion may be a discount for park tickets, or access to certain attractions (some attractions may have a higher price level to access). Promotions may apply to certain times of the day, certain days of the week. Available promotions are shown to the player.

The player can simply monitor the personal and group awards and promotions. Metering indicia can be provided to show a player how much in the way of awards has been earned and how much remains to earn in order to redeem for a good or service. For example, a circle can be displayed to the player. If the player has accumulated 50% towards redemption of an item, then 50% of the circumference can be bolded or colored in a graphical display.

The player can view the goods and services, that is the prizes that are available for redemption. For example, a free ride on an attraction, a toy, food, a T-shirt can be prizes. Each prize is priced in the amount of awards needed to redeem. Some prizes may cost more awards than other prizes. The player selects the particular prize to be redeemed. The player also selects any promotions. The player then redeems the awards and promotions. The redeemed promotion is applied to the player's account and the awards in the player's account are debited. A proof of redemption is provided to the player's mobile device. For example, a redemption code can be provided.

The player goes to the reception desk and provides the redemption code in order to receive the prize.

### DESCRIPTION OF THE PREFERRED EMBODIMENT

The loyalty application is used when the player, or user, visits an amusement park or other entertainment venue, which park is equipped with a suitable system 11. The player participates in various activities and attractions in the park. At least some of these activities yield awards to the player. The loyalty application allows the player to monitor the accumulated awards 42 and also allows the player to redeem the awards 42 for goods or services. The goods or services can be collected by the player in the park.

The loyalty application is used on a mobile device, such as a smartphone. The mobile device is possessed by a user. The loyalty application is used with an identification device 10, such as an RFID device 10. Such an RFID 10 can be worn by the player, such as on a wristband.

The loyalty application allows players to share awards 42. For example, members of a family or other group may wish to share awards 42. Players can monitor the awards 42 earned by the group and redeem those group awards. During the redemption process, available promotions can be used.

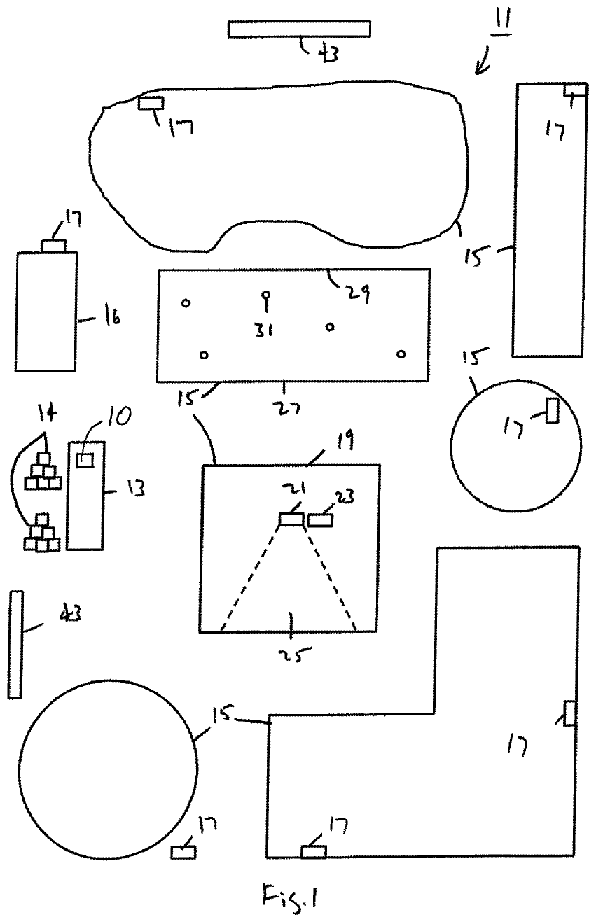

FIG. 1 illustrates an amusement park 11, or entertainment venue. The park can be indoors or outdoors. The park is a venue for entertainment activities. Such activities can involve physical play or can be games with little physical involvement. The park has a registration, or reception, desk 13 near an entry or gate. A player, or customer, enters the park and goes to the reception area to purchase tickets, access passes, RFID devices 10, etc. The RFID device 10 has a unique identifier. The player registers the player's RFID device 10, wherein the system 11 establishes an account 36 for the player, matches the identifier to the player, and obtains other information about the player for the account 36 such as payment information, etc. The account 36 also contains information on shared awards 42. The player is able to be part of a group of plural players. Each player is identified by an RFID device 10 and identifier. Awards 42 earned by any one player in the group can be shared among the group. The reception desk 13 also serves to store the various prizes 14 that players can acquire by earning and redeeming awards 42.

The park has a snack bar 16. Customers can purchase food and beverages at the snack bar. Purchases can be made in money or in redeemed awards 42.

The park has various attractions 15, or activities, such as trampolines, obstacle courses. climbing wails, etc. One attraction is a scavenger hunt. The scavenger hunt has scanner devices 17 located throughout the park. A user, or player, hunts for and locates a scanner device 17, scans the RFID device 10, receives awards 42, and moves on to hunt for another scanner device. Locating a scanner device 17 can be as simple as spotting one along a walkway, or as difficult as climbing a tall wall using handholds.

Another attraction is a video production area 19. A camera 21 is provided. A user interface and RFID scanner 23 are also provided. The player scans the RFID device 10 with the scanner, interacts with the user interface to select a particular video to be made, then stands in the area 25 in front of the camera. The camera turns on and records the user. The user interface includes a screen monitor to allow the player to view what is being recorded. The area can be provided with various backdrops. One general backdrop is a green screen, which allows images, or special effects, to be added by the system 11 to the video.

Another attraction is an arena 27. Players enter the arena and interact therewith. Images can be projected onto the walls 29 and a user can throw an object, such as a ball 31, onto the images. Participation can result in awards 42 (award credit 42) to the players.

The above are example attractions. The park can have other attractions, which may involve physical activities, such as jumping, climbing, balancing, etc., or may involve other activities.

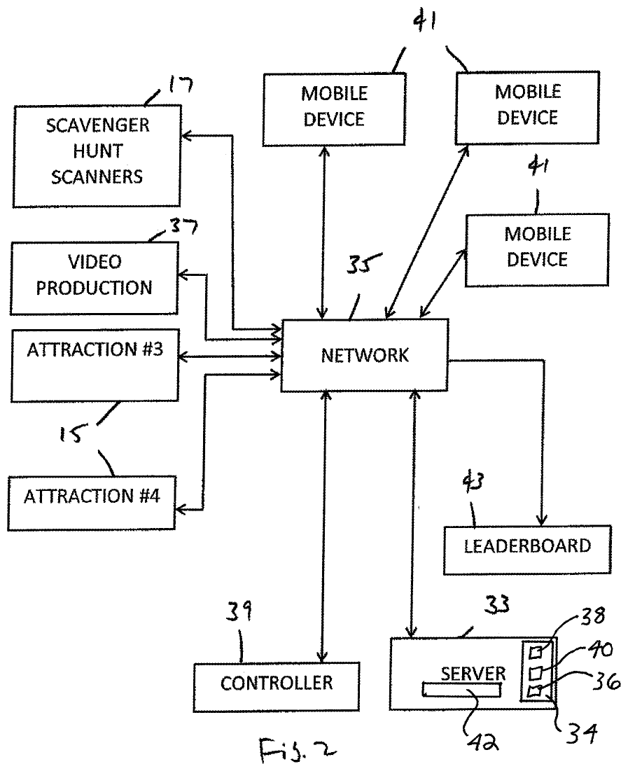

FIG. 2 shows the system 11 for use with the loyalty application. The system 11 has a server 33 that is connected to a network 35. The server 33 can be located at the park 11 or in another location. The server 33 is adapted to be communicatively linked to a database 34. The database 34 can be integral to the server 33 or accessed remotely by the server 33. In preferred embodiments, the database 34 comprises player account data 36, scanner device data 38, and group account data 40. The network 35 is connected to various devices throughout the park. For a first attraction, namely the scavenger hunt, there are a number of the RFID scanner devices 17 located throughout the park. For a second attraction, namely the video production area, the video production equipment 37, namely camera. RFID scanner and user interface, are provided. The equipment for other attractions 15, such as the arena 27, is provided as well, connected to the server over the network. The server 33 is connected over the network 35 to a controller 39, which controller can be located at the park or in another location. The controller 39 can be application software on a mobile device such as a smartphone, tablet, etc.

The server 33 is also connected, by way of the network 35, to plural player devices 41. Such player devices 41 are, in the preferred embodiment, mobile phones and smartphones. Thus, a player can access the system 11 while at the park 11. A player device can also be a desk computer, wherein the player can access the system 11 from a home, etc. located outside of the park In addition, the server 33 is connected to one or more leaderboards 43 located in the park. The leaderboards 43 (see FIG. 1) are large displays, typically elevated above the floor to allow viewing from many areas of the park 11.

The server 33 has a network adapter, as does each component connected to the network such as the scanner devices 17, the video production equipment 37, the equipment for other attractions, the controller 39, the mobile devices 41 and the leaderboards 43.

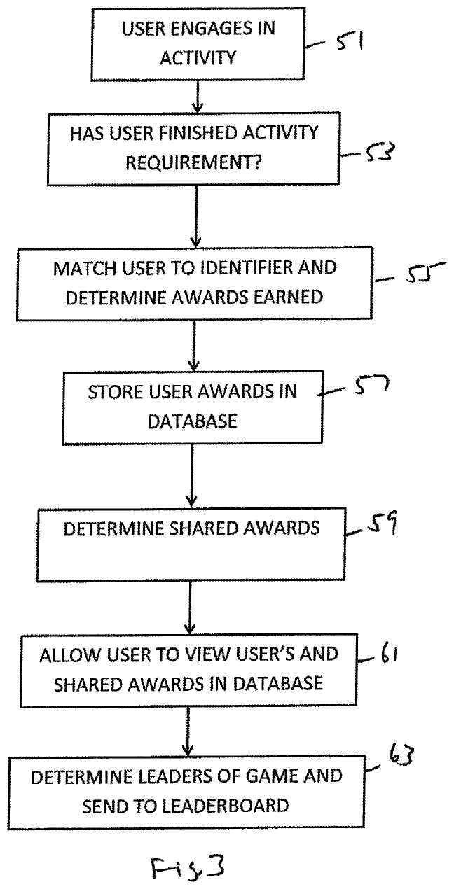

FIG. 3 illustrates the method of a player acquiring awards 42. The player engages in an activity that allows awards 42, step 51. Such an activity typically involves the player playing on or using the attraction. For example, for the scavenger hunt game, the player hunts the scanner devices 17 throughout the park and scans the player's RFID device 10. Part of the activity is finding the scanner devices. Another part of the activity is reaching the scanner devices 17 and locating the RFID devices 10 adjacent thereto for scanning. To reach some of the scanner devices, the player may need to climb, balance on a beam or other object, traverse an elevated course, etc. As another example, to produce a video, a player scans in the player's RFID device 10 at the scanner in the video area 19, selects from a library of available backdrops or video interactions, and steps in front of the camera. As the camera records, the player of course need not stay stationary, but can move and interact. For example, the equipment may provide a visual backdrop on the video, such as a surfing wave, wherein the player may wish to pantomime riding a surfboard. The player can view the video, with the surfing wave, in real time on a display. As another example, a player can share the completed video with others. Sharing can be on social media, such as with a collection of friends. Sharing can also be by entails or messaging with select individuals.

The method then determines if the player has finished the required activity, step 53. For the scavenger hunt, this is a successful scan of the RFID device 10. For the video production, this is a completed video. For sharing a video, this is the actual sharing to a common platform, such as a social media, or to a private recipient. All of these actions result in a notification sent to the server by the respective equipment. The notification provides the player's information. For example, in the case of a scanned RFID device 10, the identification from the RFID device 10 is included.

In step 55, the player's identification from the attraction is matched to the player and the player's account. In addition, the amount of awards earned by the player, if any, is determined. Various predetermined factors can be used to determine the amount of awards, such as time of day, particular attraction or activity the player engaged in, level of difficulty. Also, various rules may be applied to determine rewards. For example, when playing the scavenger hunt, a player may be unable to rescan plural times the same scanner in a predetermined period of time, so as to encourage players to hunt for other scanners. The awards 42 earned by the player are stored in a database 36, namely in the player's account 36, step 57.

In addition, the method determines the shared awards 42 of the player, step 59. The group 40 that the player belongs to is identified and the awards 42 accumulated by the group 40 are added to or updated in the player's account 36. Shared awards 42 allow a parent or guardian to monitor and redeem awards 42 on behalf of several young players. Such young players may not have a mobile device 41 themselves and may need to rely on the mobile device of the parent.

The player is allowed to view the player's account 36, step 61, by way of a player device 41. The method also determines who the leaders are among active playing players in the park, and displays a ranking on the leaderboard 53, step 63. This allows players in the park to compete against one another.

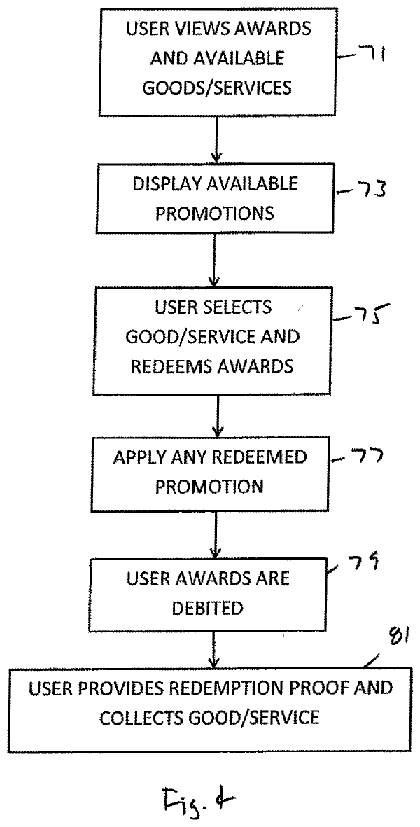

FIG. 4 shows the method for allowing a player, or parent, to monitor awards 42 and redeem rewards. A player uses the loyalty application on the mobile device 41. The player monitors the awards 42 earned, step 71. The player can monitor how the awards 42 were earned, whether from making videos, or playing games, such as the scavenger hunt, etc. The player can also monitor how many times items, such as videos, were shared by the player to another player or platform (such as social media). The player can monitor the awards 42 earned by the player individually and by the player's group.

Occasionally, promotions may be made available to player. A promotion may be a discount for park tickets, or access to certain attractions (some attractions may have a higher price level to access). Promotions may apply to certain times of the day, certain days of the week. In step 73, available promotions are shown to the player.

The player can simply monitor the personal and group awards 42 and promotions. Metering indicia can be provided to show a player how much in the way of awards 42 has been earned and how much remains to earn in order to redeem for a good or service. For example, a circle can be displayed to the player. If the player has accumulated 50% towards redemption of an item, then 50% of the circumference can be bolded or colored in a graphical display.

The player can view the goods and services, that is the prizes 14, that are available for redemption. For example, a free ride on an attraction, a toy, food, a T-shirt can be prizes. Each prize is priced in the amount of awards 42 needed to redeem. Some prizes may cost more awards 42 than other prizes. In step 75, the player selects the particular prize to be redeemed. The player also selects any promotions. The player then redeems the awards 42 and promotions. The redeemed promotion is applied to the player's account, step 77 and the awards 42 in the player's account are debited, step 79. A proof of redemption is provided to the player's mobile device, step 81. For example, a redemption code can be provided.

The player goes to the reception desk and provides the redemption, code in order to receive the prize.

The foregoing disclosure and showings made in the drawings are merely illustrative of the principles of this invention and are not to be interpreted in a limiting sense.

1. A method for providing awards via a mobile application on a mobile device to a player engaging in activities within an entertainment venue, the method comprising the steps of:
providing a system comprising a server, a network, a controller, and one or more equipment devices, the server and one or more equipment devices being communicatively linked to the network and the controller, the one or more equipment devices being adapted to receive identification data communicated by an identification device;
the one or more equipment devices being adapted to notify the server of the identification data communicated by the identification device;
the system being adapted to maintain system data comprising player account data and equipment device data;
the player account data comprising a player account comprising player account information, said player account information comprising a player account award credit total comprising player account award credit;
the equipment device data comprising data associated with the one or more equipment devices;
the mobile device being communicatively linked to the network and being adapted to display some or all of the player account information;
associating, by the server, the player account with the identification device;
determining, by the server, an additional amount of the player account award credit to be credited to the player account when at least one of the one or more equipment devices notifies the server of the identification data communicated by the identification device;
crediting, by the server, the additional amount of the player account award credit to the player account;
determining, by the server, the player account award credit total; and
permitting, by the server, some or all of the player account information to be displayed on the mobile device.

2. The method of claim 1, wherein the one or more equipment devices comprise one or more scanner devices, the one or more equipment devices being positioned within an amusement park comprising one or more attractions.

3. The method of claim 2, wherein at least one of the one or more equipment devices is positioned proximate to at least one of the one or more attractions.

4. The method of claim 3, wherein at least one of the one or more attractions is a scavenger hunt.

5. The method of claim 3, wherein at least one of the one or more attractions is a video production area.

6. The method of claim 3, wherein at least one of the one or more attractions comprises projected images.

7. The method of claim 3, wherein after the step of permitting, by the server, some or all of the player account information to be displayed on the mobile device, the step of redeeming the award.

8. The method of claim 3, wherein after the step of associating, by the server, the player account with the identification device, the step of activating a user interface when at least one of the one or more equipment devices notifies the server of the identification data communicated by the identification device.

9. The method of claim 1, wherein the identification device is an RFID device.

10. The method of claim 1, wherein the player account data further comprises a second player account, the system further comprises a leaderboard, the leaderboard being adapted to display player scores. and the method further comprising the steps of:
displaying a first player score on the leaderboard; and
displaying a second player score on the leaderboard.

11. A method for providing awards via a mobile application on mobile devices to first and second players engaging in activities within an entertainment venue, the method comprising the steps of:
providing a system comprising a server, a network, a controller, and one or more equipment devices, the server being communicatively linked to the network and the controller, the one or more equipment devices being adapted to notify the server of identification data communicated by first and second identification devices;
the system being adapted to maintain system data comprising player account data and equipment device data, the player account data comprising first and second player accounts and the equipment device data comprising data associated with the one or more equipment devices;
associating, by the server, the first player account with the first identification device and associating the second player account with the second identification device;
establishing, by the server, a group account comprising group account data;
the group account data comprising group account information comprising a group account award credit total, the group account award total comprising group account award credit;
the mobile devices being communicatively linked to the network and being adapted to display some or all of the group account information;
determining, by the server, an additional amount of group award credit to be credited to the group account when at least one of the one or more equipment devices notifies the server of the identification data communicated by the first and second identification devices;
crediting, by the server, the additional amount of group award credit to the group account; and
permitting, by the server, some or all of the group account information to be displayed on one or more of the mobile devices.

12. The method of claim 11, the system further comprising a leaderboard, the leaderboard being adapted to display player scores, the method further comprising the step of:
displaying a first player score on the leaderboard; and
displaying a second player score on the leaderboard.

13. The method of claim 11, wherein the one or more equipment devices comprises one or more device scanners, the one or more equipment devices being positioned within an amusement park comprising one or more attractions.

14. The method of claim 13, wherein at least one of the one or more equipment devices is positioned proximate to at least one of the one or more attractions.

15. The method of claim 11, wherein after the step of permitting, by the server, some or all of the group account information to be displayed on one or more of the mobile devices, the step of redeeming the award.

16. The method of claim 15, wherein after the step of redeeming the award, the step of, debiting, by the server, from the group account, an amount of group award credit attributable to redeeming the award.

17. A system for providing awards via a mobile application on a mobile device to a player engaging in activities within an entertainment venue, the system comprising:
a server, a network, a controller, and one or more equipment devices, the server being communicatively linked to the network and the controller, the one or more equipment devices being adapted to notify the server of identification data communicated by an identification device;
the system being adapted to maintain player account data and equipment device data, the player account data comprising a player account and the equipment device data comprising data associated with the one or more equipment devices;
the mobile device being communicatively linked to the network and being adapted to display player account information and a player account award credit;
the server being adapted to associate the player account with the identification device;
the server being further adapted to determine an amount of the award credit when at least one of the one or more equipment devices notifies the server of the identification data communicated by the identification device; and
the server being further adapted to generate the player account award credit and permit the award credit to be displayed on the mobile device.

18. The system of claim 17 further comprising a leaderboard, the leaderboard being adapted to display player scores.

19. The system of claim 17, wherein the identification device is an RFID device.
